(19) United States
(12) Patent Application Publication
(10) Pub. No.: US 2021/0081930 A1
(43) Pub. Date: Mar. 18, 2021

(54) SYSTEM AND METHOD FOR DECENTRALLY CARRYING OUT TRANSACTIONS

(71) Applicant: Robert Bosch GmbH, Stuttgart (DE)

(72) Inventor: Bernhard Rode, Beilstein (DE)

(21) Appl. No.: 16/970,343

(22) PCT Filed: Feb. 18, 2019
(86) PCT No.: PCT/EP2019/053938

§ 371 Date: Aug. 14, 2020

(30) Foreign Application Priority Data
Mar. 15, 2018 (DE) 10 2018 203 994.1

(51) Int. Cl. G06Q 20/38; G06Q 20/32; G06Q 20/22; G06Q 20/06

(52) U.S. Cl. CPC G06Q 20/382; G06Q 20/065; G06Q 20/223; G06Q 20/325

(57) ABSTRACT

A system is provided for decentrally carrying out transactions. The system includes at least one distributed database and at least one autonomous or semi-autonomous vehicle. At least one node of the distributed database is formed by a control unit of the at least one autonomous or semi-autonomous vehicle. The control unit of the at least one vehicle is able to perform the transactions autonomously with at least one participant of the system.

### FIELD

The present invention relates to a system for decentrally carrying out transactions, including at least one distributed database and at least one autonomous or semi-autonomous vehicle. Furthermore, the present invention relates to a method for carrying out transactions.

### BACKGROUND INFORMATION

In automated or semi-automated vehicles or robotaxis, it will be necessary for these autonomous or semi-autonomous vehicles to be able to autonomously conduct transactions. Transactions of this type may be, for example, receipts or computed travel expenses as well as bills for booked trips. Expenses, such as for example tolls, parking charges, or repair costs, may be furthermore incurred for which bills must be autonomously settled by the vehicle. These bills or transactions should be preferably carried out transparently and independently of a central institution or platform. The autonomous or semi-autonomous vehicles must be capable of autonomously making decisions in connection with the above-named transactions.

German Patent Application No. DE 102010011645 A1 describes a method for carrying out transactions via secured communication links between vehicles. In German Patent Application No. DE 102006032374 A1, it is provided to use vehicles to form nodes of a decentralized network.

Using today's technologies, which are based on centralized and non-transparent data silos, it has so far not been possible to decentrally the carry out the above-described transactions and to make the decisions connected thereto.

### SUMMARY

An object of the present invention is to provide a system and a method as the basis for transactions initiated by vehicles.

This object may be achieved with the aid of example embodiments of the present invention. Advantageous embodiments of the present invention are described herein.

According to one aspect of the present invention, a system is provided for carrying out transactions. The system includes at least one distributed database and at least one autonomous or semi-autonomous vehicle. According to the present invention, at least one node of the distributed database is formable by a control unit of the at least one autonomous or semi-autonomous vehicle, the control unit of the at least one vehicle being able to perform transactions with at least one participant of the system.

With the aid of the system, autonomous or semi-autonomous vehicles may autonomously perform transactions, the transactions being transparent and independent of a central institution or platform.

The autonomous or semi-autonomous vehicles participating in the system may, for example, form the nodes of a distributed database or a blockchain. By forming a decentralized distributed database of this type, the transactions to be carried out may be trustworthily displayed via smart contracts, for example.

The transactions may be preferably initiated by the at least one vehicle and/or by other participants, such as potential passengers, for example, and contracted between the at least one vehicle and the participant. The transactions may be in particular carried out with the aid of the control units or control devices of the vehicles. The control units preferably include data memories and communication devices. In this way, communication links to other nodes may be established and data may be processed. In this case, the control units may be based on a microcontroller technology or on a microprocessor technology.

The transactions may be deals for transportation of one or multiple passengers for a defined route, for example. Different factors, such as for example the duration of a trip, fast or slow driving behavior of the at least one vehicle, upcoming repairs, intermediate destinations, and the like, may be implemented in a pricing or a transportation term of passengers.

Furthermore, transactions that may be carried out between the at least one vehicle and a repair shop may include maintenance or repair contracts for ensuring a safe state of the at least one autonomous or semi-autonomous vehicle.

According to one exemplary embodiment of the system, the distributed database is a blockchain. In the field of blockchain technology, open, transparent, and highly automated transaction processes may be displayed by implementing smart contracts. The information corresponding to the transactions may be decentrally processed and stored and thus manufacturer- or fleet-independently of one another. All transactions may be preferably retrieved, displayed and validated by every participant participating in the system.

According to a further exemplary embodiment of the system according to the present invention, the distributed database has at least one partition. By integrating additional partitions into the blockchain, certain activities, such as for example a transportation of persons and servicing or maintenance of vehicles, may be separated from one another. In this way, it is possible to implement a clear division of the transactions that is more easily checkable for an operator of the autonomous or semi-autonomous vehicles.

According to a further exemplary embodiment of the system according to the present invention, the at least one node of the distributed database is formable by at least one vehicle-external control unit. A vehicle-external control unit may be, for example, a computer of a toll station or of a repair shop. Furthermore, the vehicle-external control unit may be an integral part of an infrastructure. In this way, the at least one autonomous or semi-autonomous vehicle may communicate and interact with the vehicle-external and in particular stationary participants of the system.

According to a further exemplary embodiment of the system of the present invention, the transactions are designed in the form of smart contracts. In the distributed database, the transactions needed by a vehicle are preferably displayed via smart contracts.

Nowadays, most applications in the case of communication that is relevant to all vehicles are implemented through classic communication methods or via central data management. These always require mutual trust that may be lost in the case of legal processes. By using blockchain technologies and their inherent distributed, trustworthy data management, this needed trust may be technically ensured. The smart contracts are thus implementable in the distributed database according to one preferred exemplary embodiment of the system.

The transactions implemented in the smart contracts may be used by the at least one autonomous or semi-autonomous vehicle itself or automatically or by a customer, or a Car2X communication, or the like. Each participant in the system may initiate and transparently reproduce all transactions via the smart contracts.

According to a further exemplary embodiment of the present invention, the system includes at least one central database that is connectable to the distributed database and/or to the control unit of the at least one vehicle in a data-conducting manner. The system may thus be expanded to include a classic centralized system or a centralized database. A central database of this type may for example provide a fleet management that assists the autonomous or semi-autonomous vehicles with making certain decisions or may intervene in the case of lack of clarity.

According to a further exemplary embodiment of the system in accordance with the present invention, each vehicle includes a communication device for establishing a communication link and at least one secured communication link is establishable between at least two vehicles. With the aid of these measures, it is possible to implement a secured communication link between at least two participants or nodes of the system.

With the aid of cryptographic methods, it may moreover be ensured that no manipulations are performed on the system. The protection of the communication links may take place for example with the aid of checksums, certificates, encryptions or codifications and the like.

According to a further exemplary embodiment of the system of the present invention, the at least one participant is at least one customer, one vehicle and/or one vehicle-external infrastructure unit. The system according to the present invention may thus be used with particular versatility and flexibility.

According to a further exemplary embodiment of the system in accordance with the present invention, a communication link is establishable between the at least one vehicle and the at least one vehicle-external infrastructure unit for carrying out transactions. The autonomous or semi-autonomous vehicles may thus not only communicate with one another and thus form mobile decentralized nodes of a blockchain, but in addition also integrate stationary computers and control units into the blockchain.

It is thus possible to take into consideration bills for travel expenses and booked trips, expenses and fees for tolls, parking as well as repair and maintenances costs of the vehicles in a decentralized manner and based on the distributed database formed by the autonomous or semi-autonomous vehicles. The autonomous or semi-autonomous vehicles may thus autonomously take care of maintenance intervals in a repair shop and settle corresponding bills via stored means of payment. This allows for the automatic guarantee of the safety of the particular vehicles to be technically implemented.

According to a further exemplary embodiment of the system in accordance with the present invention, the at least one vehicle includes an input and an output unit for communicating with at least one customer and for initiating transactions. The at least one vehicle may hereby communicate with customers and passengers and receive customer wishes or implement them into the pricing. Destination inputs and intermediate destinations may be furthermore communicated by a customer to the autonomous or semi-autonomous vehicle.

According to a further aspect of the present invention, an example method is provided for carrying out transactions with the aid of a system according to the present invention. At least one distributed database is formed by the control units of at least two vehicles. At least one transaction is carried out between at least one vehicle and at least one participant of the system by designing blockchain-based smart contracts.

Transactions may be technically implemented in this way. Each of the autonomous or semi-autonomous vehicles has one or multiple control units that may communicate with one another across all relevant vehicles. The communication preferably takes place via corresponding communication devices that are situated at or in the vehicle. The control units may thus be interconnected among one another and form nodes of a distributed database or a blockchain. Corresponding blockchain-based smart contracts or agreements and contractual interactions between all relevant vehicles may have an optimized trustworthiness and be particularly transparent for customers. This makes it technically particularly easily possible to implement an automation of the transactions.

Below, preferred exemplary embodiments of the present invention are explained in greater detail with reference to the highly simplified schematic representations in the figures.

### BRIEF DESCRIPTION OF THE DRAWINGS

FIG. 1 shows a schematic representation of a system according to one first specific embodiment of the present invention.

FIG. 2 shows a schematic representation of a system according to one second specific embodiment of the present invention.

FIG. 3 shows a schematic representation of a system according to one third specific embodiment of the present invention.

FIG. 4 shows a schematic representation of a system according to one fourth specific embodiment of the present invention.

### DETAILED DESCRIPTION OF EXAMPLE EMBODIMENTS

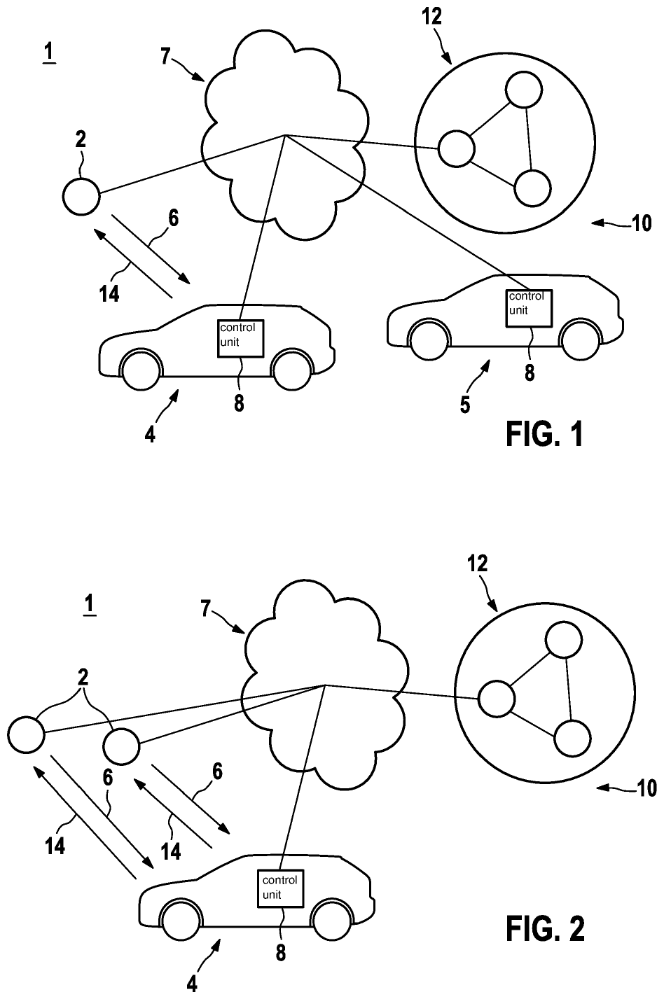

FIG. 1 shows a schematic representation of a system 1 according to one first specific embodiment of the present invention. The method according to the present invention may be illustrated in particular with reference to system 1 according to the different specific embodiments.

System 1 indicates in this case a transaction between a passenger 2 and an autonomous or semi-autonomous vehicle 4. This transaction represents a so-called car-to-customer transaction.

System 1 has a passenger 2 who plans a trip with vehicle 4 along a route. A corresponding request 6 is sent from passenger 2 via a cloud or an Internet connection 7 to a control unit 8 of vehicle 4. Control unit 8 of vehicle 4 forms one of several nodes of a distributed database 10. A further vehicle 5 is illustrated by way of example that also has a control unit 8 as a node of distributed database 10.

Distributed database 10 is a so-called blockchain 10 according to the exemplary embodiment. Based on smart contracts 12 stored in blockchain 10, vehicle 4 or control unit 8 may respond to request 6 of passenger 2 and transmit corresponding time information and pricing information 14 to passenger 2. This may be transmitted, for example, through a display or through a portable device of passenger 2. The portable device may be a tablet or a smartphone in this case.

FIG. 2 shows a schematic representation of a system 1 according to one second specific embodiment of the present invention. In contrast to the first specific embodiment, system 1 has two pricing requests 6 from two potential passengers 2 that are transmitted to a vehicle 4.

Vehicle 4 may compute a shared trip for two persons 2 with the aid of control unit 8 based on the access to smart contracts 12, by which the fare transmitted to each passenger 2 may be halved. Two transactions 6, 14, each including one request 6 and one response 14, are thus carried out with two passengers 2. A consent of passengers 2 to response 14 of vehicle 4 is not taken into consideration for the sake of simplicity, but it may be implemented in the transaction in a technically simple manner.

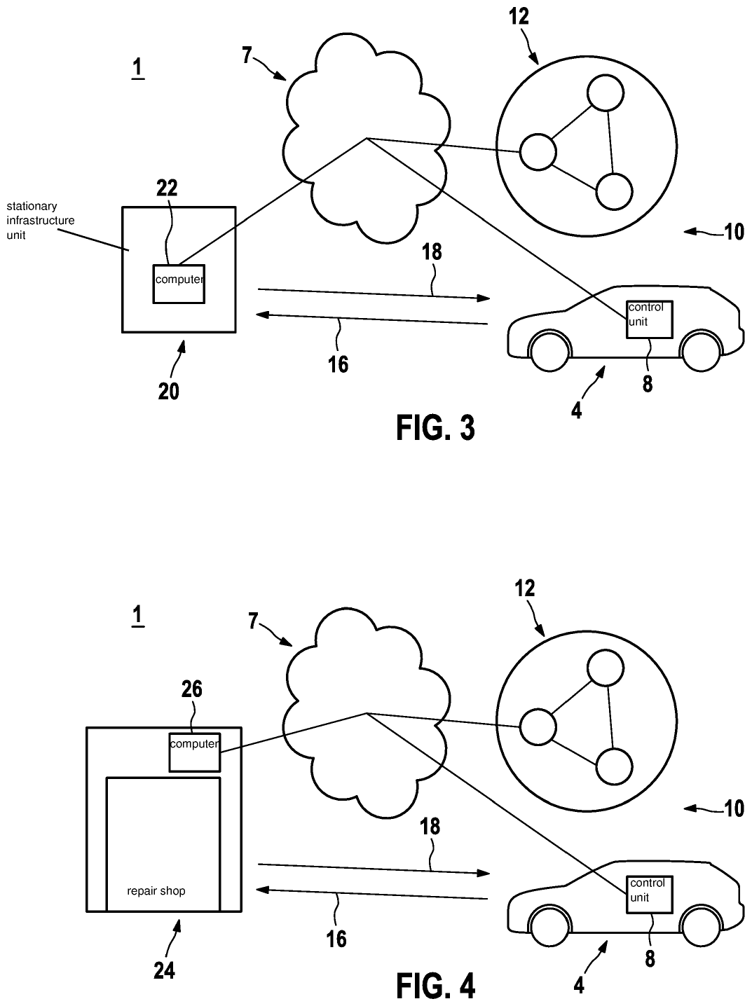

FIG. 3 illustrates one third specific embodiment of system 1 according to the present invention. Here, a transaction 16, 18 between vehicle 4 and a toll station 20 is carried out. Toll station 20 is in this case a vehicle-external stationary infrastructure unit 20 including a computer 22 that also forms a node of distributed database 10 and has therefore access to smart contracts 12. Corresponding transaction 16, 18 is a so-called car-to-infrastructure transaction 16, 18. Vehicle 4 communicates to toll station 20 that it travels on a route that is subject to toll. The incurring costs are charged or billed to vehicle 4 as response reaction 18. The costs may be billed in particular to a vehicle owner or a registered keeper. This process may be carried out by autonomous or semi-autonomous vehicle 4 or by control unit 8 in an automated manner.

One fourth specific embodiment of system 1 according to the present invention is illustrated in FIG. 4. In contrast to the third specific embodiment, system 1 according to the fourth specific embodiment has a transaction 16, 18 between a vehicle 4 and a repair shop 24. For this purpose, repair shop 24 has a computer 26 that acts as a decentralized node of distributed database 10 and may implement a trustworthy and transparent pricing based on smart contracts 12 when ascertaining the maintenance costs or repair costs.

Vehicle 4 ascertains, for example, a marginal tire wear and automatically initiates a request to a preferred repair shop 24. A request 16 with regard to new tires is responded to 18 by repair shop 24. Response 18 in this case contains a possible appointment at the repair shop, the price for the tire exchange as well as the price for the tires themselves, delivery times and the like. In this way, vehicle 4 is capable of automatically ensuring its own safety.

1-12. (canceled)

13. A system for decentrally carrying out transactions, comprising:
at least one distributed database; and
at least one autonomous or semi-autonomous vehicle;
wherein at least one node of the distributed database is formed by a control unit of the at least one autonomous or semi-autonomous vehicle, the control unit of the at least one vehicle being configured to perform the transactions autonomously with at least one participant of the system.

14. The system as recited in claim 13, wherein the distributed database is a blockchain.

15. The system as recited in claim 13, wherein the distributed database has at least one partition.

16. The system as recited in claim 13, wherein at least one node of the distributed database is formable by at least one vehicle-external control unit.

17. The system as recited in claim 13, wherein the transactions are in the form of smart contracts.

18. The system as recited in claim 17, wherein the smart contracts are implementable in the distributed database.

19. The system as recited in claim 13, wherein the system includes at least one central database that is connectable in a data-conducting manner to: (i) the distributed database and/or (ii) the control unit of the at least one vehicle.

20. The system as recited in claim 13, wherein each vehicle includes a communication device for establishing a communication link, and at least one secured communication link is establishable between at least two vehicles.

21. The system as recited in claim 13, wherein the at least one participant is: (i) at least one customer, and/or (ii) a vehicle, and/or (iii) a vehicle-external infrastructure unit.

22. The system as recited in claim 21, wherein a communication link is establishable between the at least one vehicle and the at least one vehicle-external infrastructure unit, for carrying out the transactions.

23. The system as recited in claim 13, wherein the at least one vehicle includes an input and an output unit for communicating with at least one customer and for initiating the transactions.

24. A method for carrying out transactions in a system, the system including at least one distributed database, and at least one autonomous or semi-autonomous vehicle, wherein at least one node of the distributed database is formed by a control unit of the at least one autonomous or semi-autonomous vehicle, the control unit of the at least one vehicle being configured to perform the transactions autonomously with at least one participant of the system, the method comprising the following steps:
forming the at least one distributed database by control units of at least two vehicles or at least one infrastructure unit; and
carrying out at least one transaction between the at least one vehicle and the at least one participant of the system using blockchain-based smart contracts.
